(19) United States
(12) Patent Application Publication
(10) Pub. No.: US 2018/0343713 A1
(43) Pub. Date: Nov. 29, 2018

(54) MICROWAVE HEATING APPARATUS AND METHOD OF HEATING

(71) Applicants: Commonwealth Scientific and Industrial Research Organisation, Acton ACT (AU); Horticulture Innovation Australia Limited, Sydney, New South Wales (AU)

(72) Inventors: Piotr Swiergon, Acton ACT (AU); Peerasak Sanguansri, Acton ACT (AU); Thambaramala Gamage, Acton ACT (AU); Kai Knoerzer, Acton ACT (AU); Xinqing Xu, Acton ACT (AU); Nguyen Tran, Acton ACT (AU)

(73) Assignees: Commonwealth Scientific and Industrial Research Organisation, Acton ACT (AU); Horticulture Innovation Australia Limited, Sydney, New South Wales (AU)

(21) Appl. No.: 15/757,183

(22) PCT Filed: Sep. 2, 2016
(86) PCT No.: PCT/AU2016/050836

§ 371 Date: Mar. 2, 2018

(30) Foreign Application Priority Data
Sep. 3, 2015 (AU) 2015903603

(51) Int. Cl. H05B 6/80; H05B 6/72; A23L 3/01; H05B 6/78; B01J 19/12

(52) U.S. Cl. CPC H05B 6/80; H05B 6/725; H05B 2206/045; H05B 6/78; B01J 19/126; A23L 3/01

(57) ABSTRACT

A microwave heating apparatus and method of heating. The microwave heating apparatus including: a housing that contains a heating chamber adapted to receive an article to be heated, the chamber being at least partially defined by electromagnetic shielding; a microwave source for generating microwaves, the microwave source being located outside of the heating chamber; and an antenna arranged substantially within the heating chamber and configured to supply the generated microwaves substantially within the heating chamber, the antenna being configured to directly deliver the generated microwaves to the article in a substantially uniform manner. The method of heat treating organic matter with a microwave heating apparatus including a microwave source located outside of a heating chamber, the method including: generating microwaves with the microwave source; supplying the generated microwaves within the heating chamber with an antenna arranged substantially within the heating chamber, wherein the antenna comprises a loop that extends about an internal circumference of the heating chamber; introducing the organic matter into the heating chamber and through the loop via an opening of the heating chamber; heating the organic matter with the generated microwaves; removing the organic matter from the heating chamber through a further opening of the heating chamber.

### TECHNICAL FIELD

The disclosure relates, generally, to a microwave heating apparatus and, more particularly, to a microwave heating apparatus having an improved antenna for supplying microwaves. The disclosure has particular, but not necessarily exclusive, application to microwave disinfestation treatment and methods for microwave disinfestation treatment.

### BACKGROUND

Current domestic or industrial microwave heating devices use a waveguide structure to direct electromagnetic waves into the heating cavity. Waveguides are most commonly used to transfer electromagnetic power efficiently from one point to another. Some typical guiding structures utilised in waveguides include coaxial cable, two-wire and microstrip transmission lines, hollow conducting waveguides and optical fibres.

During domestic microwave waveguide heating, many variables in the food, packaging, and the microwave oven itself affect how the food is heated. Multicomponent foods in particular heat unevenly, causing problems with both sensory and microbiological quality. One of the main factors affecting the heating uniformity of foods in microwave heating ovens is the interaction between electromagnetic waves, the oven and the food.

There is a need for an improved microwave heating apparatus that addresses the abovementioned problems, and particularly the phenomenon of uneven heating. There is also the need for an improved microwave heating apparatus that can provide uniform and controlled heating of food stuffs or organic material.

### SUMMARY

In a first aspect, there is provided a microwave heating apparatus including: a housing that contains a heating chamber adapted to receive an article to be heated, the chamber being at least partially defined by electromagnetic shielding;

a microwave source for generating microwaves, the microwave source being located outside of the heating chamber; and

an antenna arranged substantially within the heating chamber and configured to supply the generated microwaves substantially within the heating chamber, the antenna being configured to directly deliver the generated microwaves to the article in a substantially uniform manner.

A particular advantage of the microwave heating apparatus described is that it specifically addresses the phenomenon of uneven heating by reducing areas of higher and lower temperature differential in (or on) the article being heating. For example, the microwave heating apparatus reduces the creation of ‘hot spots’ in the article being heated. It may also remove the need for a waveguide to directly introduce microwaves to the heating chamber by providing an antenna that couples to a magnetron to transmit electromagnetic waves. The use of an antenna allows for a relatively even “flooding” of the heating chamber with electromagnetic waves that diffuse throughout the length of the antenna. In addition, this design allows for more uniform delivery of microwaves across a wider heating chamber such as, for example, a heating chamber incorporating a conveyor belt system for transfer of articles (e.g. food stuffs or organic material) through the heating chamber.

The antenna may be a co-planar loop that extends about the heating chamber. In one embodiment, the antenna may have an overall shape that approximates an ellipse as it extends about the heating chamber. For example, the antenna may take the shape of, for example, an elongated hexagon or octagon that approximates an ellipse as it extends about the heating chamber.

The positioning of the antenna within the heating chamber will depend on the article to be heated, and the configuration of the housing and/or heating chamber. For example, in a basic configuration, the antenna may be located at the top of the heating chamber (and above the article) so as to directly deliver the generated microwaves to the article in a substantially uniform manner. Such a configuration assumes that the article will be placed approximately centrally within the heating chamber. The reference in this paragraph to microwaves being ‘directly’ delivered to the article should be understood as referring to microwaves that travel directly from the antenna to the article, and excluding those microwaves that are received at the article after reflecting off an internal wall of the housing and/or heating chamber (i.e. microwaves that are ‘indirectly’ delivered to the article).

In an alternative embodiment, the antenna (or a portion thereof) is coiled in a helical configuration. For example, the antenna may extend about the heating chamber in a helical coil, having one or more of its ends in connection with the microwave source.

The antenna may also be configured with a plurality of helical turns along its length. In a preferred embodiment, the diameter of these turns is approximately 10 mm, although it should be appreciated that other configurations are also possible depending on the type of antenna and type of microwave source used.

The geometry of the antenna may also provide significant advantages. A coaxial rod configured as a substantially co-planar loop allows for relatively uniform distribution of electromagnetic wave throughout the heating chamber. A coiled or helically-coiled antenna design has the additional advantage of modifying the supplied electromagnetic wave (and simulating a rotating field when an article is conveyed through the heating chamber), which is understood to reduce energy focussing and provide a more uniform distribution (and heating) within the article being heated. The supplied microwaves may, for example, be circularly polarised.

A further advantage of the stated design is that, unlike traditional waveguides that require complete system redesign for different frequencies, the antenna design only requires a change in launcher configuration (i.e. the interface between the magnetron and the antenna) and an alternative frequency magnetron. It does not require any additional changes to the heating chamber or antenna structure. This means that the microwave heating apparatus can be customised for different applications using various combinations of frequency modules (e.g. multiple consecutive antenna segments and/or magnetrons) to achieve targeted treatment or heating objectives, which provides additional flexibility for customisation far beyond existing waveguide systems.

The housing may be configured with a first opening to facilitate introduction of the article to the heating chamber. The housing may also be configured with a second opening to facilitate removal of the article from the heating chamber. In one embodiment, the first opening and second opening may be one and same (i.e. a single opening may be used for both the introduction of the article to the heating chamber, and the removal of the article from the heating chamber).

Alternatively, the first opening and second opening may be separate and distinct (i.e. the housing may have a first opening that allows the introduction of the article, and a second opening that allows the removal of the article). In such a configuration, the housing may define a tunnel that extends through the heating chamber.

The microwave heating apparatus may further include a conveyor that extends into and/or through the heating chamber. The conveyor may include a conveyor belt that facilitates introduction and/or removal of the article from the heating chamber. In some embodiments, the conveyor may extend through the first and second openings so as to automate the introduction of the article to the heating chamber, as well as the removal of the article from the heating chamber.

The electromagnetic shielding may be constructed from a material that reflects and/or absorbs electromagnetic radiation such as, for example, sheet metal, metal mesh/screen, or metal foam. For example, a common electromagnetic shielding material may be a metal mesh having holes that are significantly smaller than the wavelength of the microwaves being supplied by the antenna within the heating chamber. The electromagnetic shielding may define at least a portion of the heating chamber. For example, the electromagnetic shielding may consist of a number of surfaces that define an area within which the generated microwaves are contained. Alternatively, or in addition, a portion of the electromagnetic shielding may be affixed to a closure (e.g. a door) that allows one or more of the first opening and second opening to be closed. It should also be appreciated that the housing may function as the electromagnetic shielding, in which case the heating chamber is substantially defined by the housing.

An internal profile of the electromagnetic shielding may be configured to match the shape of the antenna. For example, if the antenna has an overall shape that approximates an ellipse as it extends about the heating chamber, then the surrounding profile of the electromagnetic shielding (i.e. the cross section of the electromagnetic shielding) would also have a shape that approximates an ellipse.

The separation between the antenna and the electromagnetic shielding may be substantially uniform as the antenna extends about the heating chamber. For example, and as previously discussed, if the antenna has an overall shape that approximates an ellipse as it extends about the heating chamber, then the surrounding profile of the electromagnetic shielding would also have a shape that approximates an ellipse, and have a relatively uniform separation from the antenna as it extends about the heating chamber. An advantage of this configuration is that any microwaves not directly delivered to the article are reflected off the electromagnetic shielding in a relatively uniform manner such that heating of the article maintains relative uniformity (i.e. no individual ‘hot spots’ are created during the heating of the article). In other words, the microwaves indirectly delivered to the article are delivered in a substantially uniform manner.

The microwave source may include a magnetron configured to generate microwaves of a particular frequency, or within a predefined frequency range. The specific type of magnetron used may vary depending on the desired frequency of microwaves to be generated. However, the types of magnetrons may include single anode magnetrons, split anode magnetrons, cavity (or electron-resonance) magnetrons, or solid-state magnetrons.

The magnetron may be powered by a regulated high-voltage power supply. An advantage of using such a power supply is that it avoids the need to regulate power through ‘pulsing’ (i.e. rapidly switching the power on and off), which in turn increases the longevity of the magnetron.

In a second aspect, there is provided a microwave disinfestation apparatus including:

a housing that contains a heating chamber adapted to receive organic matter to be heated, the chamber being at least partially defined by electromagnetic shielding;

a microwave source for generating microwaves, the microwave source being located outside of the heating chamber;

a conveyor that extends through openings in the housing, the conveyor being configured to convey the article through the heating chamber; and

an antenna arranged substantially within the heating chamber and configured to supply the generated microwaves within the heating chamber, the antenna being configured to directly deliver the generated microwaves to the organic matter and bring about substantially uniform heating of the organic matter.

The antenna may include one or more of:

a co-planar antenna loop segment coupled to at least one magnetron; and

a helically-coiled antenna segment coupled to at least one magnetron.

Depending on the specific configuration, the antenna may include a sequence of consecutive co-planar antenna loop segments and/or helically-coiled antenna segments that extend about the heating chamber. In such a configuration, the sequence of co-planar antenna loop segments and/or helically-coiled antenna may be in connection with one or more magnetrons that generate the required microwaves.

The antenna may be configured with a plurality of helical turns along its length. As discussed above, in a preferred embodiment, the diameter of these turns is approximately 10 mm, although it should be appreciated that other configurations are also possible depending on the type of antenna and type of microwave source used.

In a third aspect, there is provided a method of heat treating organic matter with a microwave heating apparatus including a microwave source located outside of a heating chamber, the method including: generating microwaves with the microwave source; supplying the generated microwaves within the heating chamber with an antenna arranged substantially within the heating chamber, wherein the antenna comprises a loop that extends about an internal circumference of the heating chamber; introducing the organic matter into the heating chamber and through the loop via an opening of the heating chamber; heating the organic matter with the generated microwaves; removing the organic matter from the heating chamber through a further opening of the heating chamber.

In some embodiments, the supplied microwaves result in substantially uniform heating of the organic matter.

In some embodiments, the method further includes cooling the organic matter after the heating.

In some embodiments, the heating chamber is defined by electromagnetic shielding.

In some embodiments, the organic matter may also be continuously introduced into and continuously removed from the heating chamber. The generating microwaves may include generating microwave pulses.

In some embodiments, the organic matter is substantially uniformly heated for a predetermined equivalent time at a predetermined temperature.

In some embodiments, the predetermined temperature is in the range of 40° C. to 60° C. The predetermined temperature may, in some embodiments, be either 45° C. or 52° C.

In some embodiments, the predetermined equivalent time at the predetermined temperature is in the range of 10 to 60 minutes. The predetermined equivalent time at the predetermined temperature may alternatively be in the range of either 15 to 25 minutes or 26 to 40 minutes.

In some embodiments, the method includes using the microwave heating apparatus is defined in accordance with the first or second aspects.

### BRIEF DESCRIPTION OF DRAWINGS

An embodiment of the disclosure is now described by way of example with reference to the accompanying drawings in which: —

FIG. 1 shows a schematic diagram of an embodiment of a microwave heating apparatus;

FIG. 2 shows a perspective view of an embodiment of a microwave heating apparatus;

FIG. 3 shows a perspective view of an embodiment of a microwave heating apparatus;

FIG. 4A and FIG. 4B show a perspective view of an embodiment of an antenna in a co-planar loop configuration;

FIG. 5A and FIG. 5B show a perspective view of an embodiment of a coiled antenna in a co-planar loop configuration;

FIG. 6A and FIG. 6B show a perspective view of an embodiment of an antenna in a helically-coiled configuration;

FIG. 7A and FIG. 7B show a perspective view of an embodiment of a coiled antenna in a helically-coiled configuration;

FIG. 8 shows a perspective view of an embodiment of a microwave heating apparatus; and

FIG. 9 shows a flowchart of a method of heat treating a material.

### DESCRIPTION OF EMBODIMENTS

In the drawings, reference numeral 10 generally designates an embodiment of a microwave heating apparatus. The microwave heating apparatus 10 is particularly useful in relation to microwave disinfestation treatment and methods for microwave disinfestation treatment and it will therefore be convenient to describe the apparatus 10 in that environment. However, it should be understood that the apparatus 10 is not limited to this embodiment, and may be utilised or implemented in other environments or application.

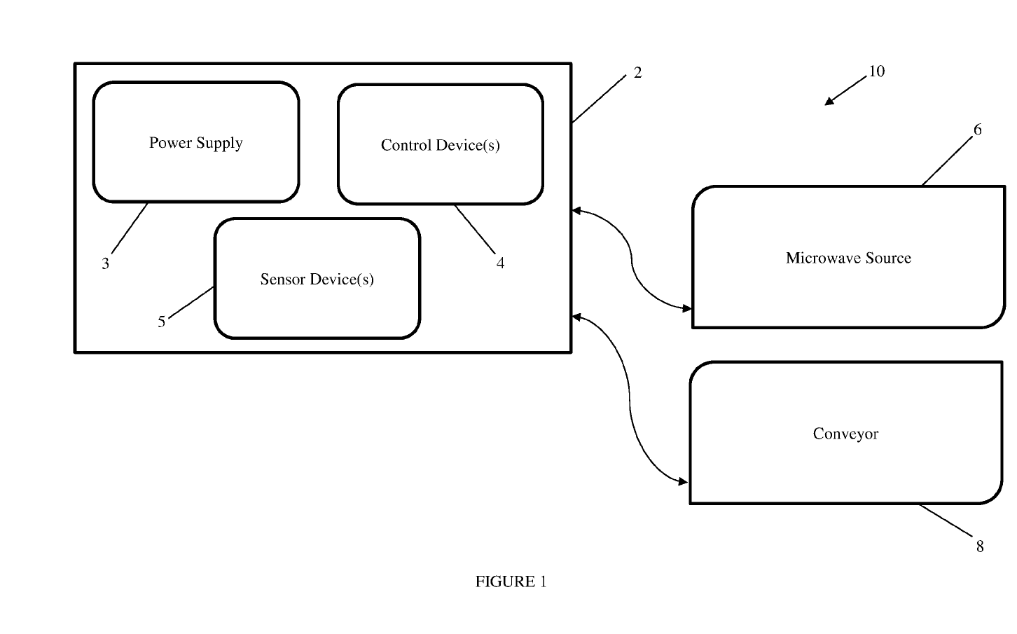

As illustrated in the block diagram shown at FIG. 1 of the drawings, the apparatus 10 includes a control system 2 that preferably includes a regulated high-voltage power supply 3, one or more control devices 4 for controlling operation (and/or activation) of the power supply 3, and one or more sensor devices 5. In addition, the apparatus 10 includes a microwave source 6 such as, for example, a magnetron that generates the necessary microwave energy. Furthermore, the apparatus 10 also includes a conveyor 8 that facilitates the treatment of an article in accordance with the microwave disinfestation treatment process described in further detail below.

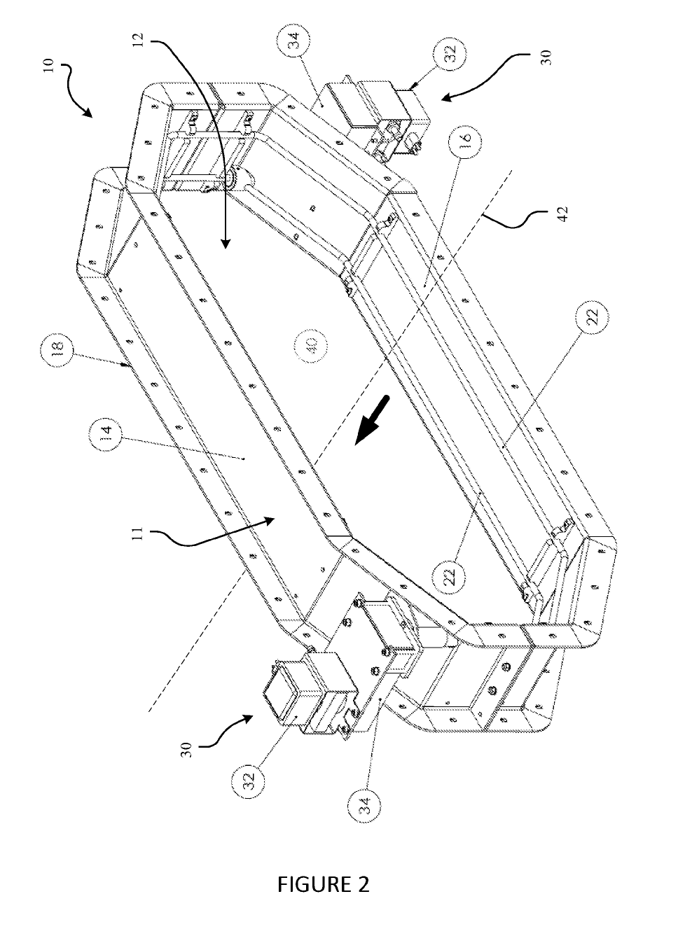

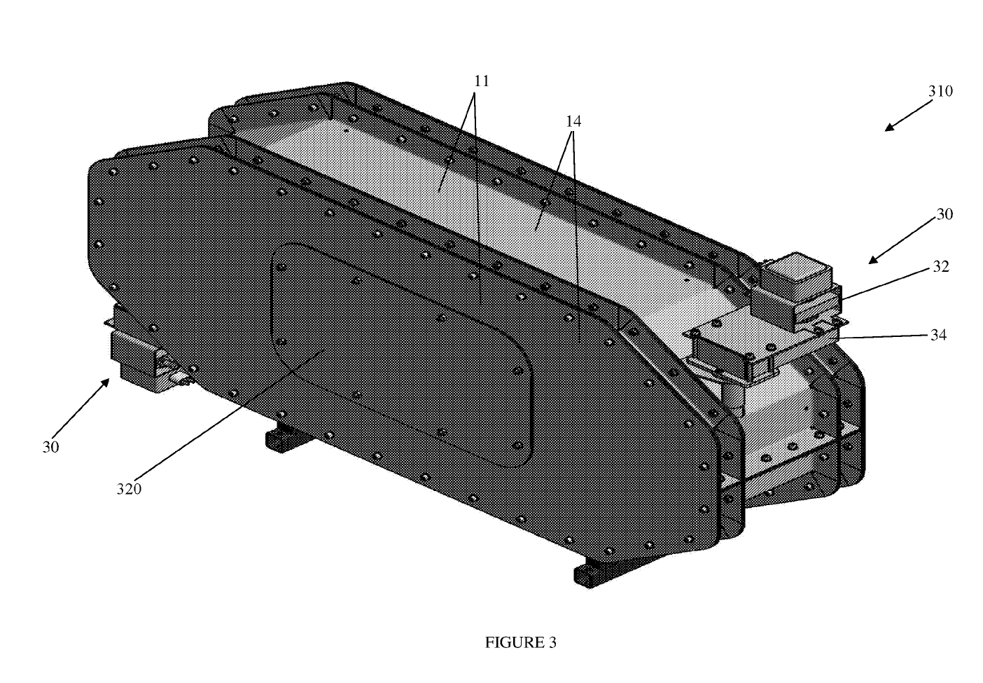

The apparatus 10 includes a housing 11 that contains a heating chamber 12 that is adapted to receive an article to be heated (not shown). The heating chamber 12 is at least partially defined by electromagnetic shielding 14. The electromagnetic shielding 14 is preferably constructed from a material that reflects and/or absorbs electromagnetic radiation such as, for example, sheet metal, metal mesh/screen, or metal foam. The electromagnetic shielding 14 illustrated in FIG. 2 and FIG. 3 of the drawings is sheet metal, although it should be appreciated that other suitable shielding materials could also be used. For example, a common electromagnetic shielding material is a metal mesh having holes that are (on average terms) significantly smaller than the wavelength of the microwaves being supplied by the antenna within the heating chamber.

In one embodiment, and as shown in FIGS. 2 and 3 of the drawings, the housing 11 and the electromagnetic shield 14 are one in the same. In accordance with this embodiment, the housing 11 is preferably constructed from a material that reflects and/or absorbs electromagnetic radiation such as, for example, sheet metal, metal mesh/screen, or metal foam. In an alternative embodiment, the electromagnetic shield 14 is contained within the housing 11. In accordance with this embodiment, the housing 11 may perform a superficial function and, as such, be constructed from, for example, a plastic material so as to produce an aesthetically appealing appearance for the apparatus 10. As a result, and according to this embodiment, the heating chamber 12 may be completed defined by the electromagnetic shield 14. However, it should also be appreciated that further cosmetic lining (e.g. non-metallic lining that does not substantially influence the behaviour of microwave energy within the heating chamber 12) may be incorporated within the heating chamber 12 (i.e. within the confines of the electromagnetic shielding 14) to better facilitate the placement of articles within the heating chamber 12 during heating and/or treatment.

The heating chamber 12 is configured with a first opening 16 to facilitate introduction of the article (not shown) to the heating chamber 12. In a preferred embodiment, the heating chamber 12 is also configured with a second opening 18 to facilitate removal of the article from the heating chamber 12. The first opening 16 and second opening 18 are ordinarily positioned on opposing sides of the heating chamber 12, although it should be appreciated that other configurations are also possible.

In some embodiments, the introduction of the article to the heating chamber 12 and the removal of the article from the heating chamber 12 may occur via the same opening, in which case the first opening 16 and second opening 18 are one and the same.

The electromagnetic shielding 14 may define at least a portion of the heating chamber 12 (as previously described). For example, and as shown in FIG. 2 of the drawings, the electromagnetic shielding 14 may consist of a number of walls or surfaces that define an area within which the generated microwaves are contained. Alternatively, FIG. 3 of the drawings shows microwave heating apparatus 310 where an additional portion(s) of the electromagnetic shielding 14 may be utilized as or affixed to a closure 320 (e.g. a door) that allows one or more of the first opening 16 and second opening 18 to be opened and closed as required. As such, it should be appreciated from the drawing in FIG. 3 that the heating chamber 12 may be fully enclosed or enclosable respectively by the electromagnetic shielding 14 if required for a particular application.

As shown in FIG. 2 of the drawings, the housing 11 includes a first opening 16 and second opening 18 that define a tunnel 40 that extends through the heating chamber 12 (as depicted by the arrow shown in FIG. 2). In accordance with such an embodiment, the apparatus 10 may also include a conveyor 8 that extends into and through the tunnel 40, and therefore into and/or through the heating chamber 12. The conveyor 8 is preferably a conveyor system (e.g. a conveyor belt) that facilitates the introduction and/or removal of the article (not shown) from the heating chamber 12. In a particularly preferred embodiment, the conveyor 8 may extend through the first opening 16 and second opening 18 so as to automate the introduction of the article (not shown) to the heating chamber 12, as well as the removal of the article from the heating chamber 12. In accordance with this embodiment, the control system 2 may further incorporate for example, as part of the control devices 4, one or more motor controllers to control both the speed at which the article is introduced to and removed from the heating chamber 12, and the duration for which the article is positioned within the heating chamber 12 for heating and/or treatment.

In some embodiments, the conveyor 8 includes a belt, a set of rollers, a chute, or any combination of components to assist in transporting the organic material through the tunnel 40 and/or the heating chamber 12.

The apparatus 10, 310 further includes a microwave source 30 for generating microwaves. The microwave source 30 is preferably located outside of the heating chamber 12 and includes a magnetron 32 for generating microwaves of a particular frequency (e.g. about 2.45 GHz) or within a desired frequency band (e.g. the S-band in the range of 2 to 4 GHz). The specific type of magnetron used may vary depending on the desired frequency of microwaves to be generated. However, the types of magnetrons may include single anode magnetrons, split anode magnetrons, cavity (or electron-resonance) magnetrons, or solid-state magnetrons. Depending on the specific type of magnetron used, a waveguide 34 may also be incorporated to facilitate the transfer of generated microwaves. However, for example, when using a solid-state magnetron (not shown) a waveguide 34 would not be required. In some embodiments an adapter is used to couple the antenna 22 to the magnetron 32. For example, a waveguide to coaxial antenna adapter may be used.

The magnetron 32 is preferably powered by a regulated high-voltage power supply (not shown). An advantage of using such a power supply is that it avoids the need to regulate power through ‘pulsing’ (i.e. rapidly switching the power on and off), which in turn increases the longevity of the magnetron 32. In some embodiments, the magnetron 32 operates at a power in the range of 0.5 to 3 kW. In some embodiments, the magnetron 32 operates at a power of more than 1 kW.

The apparatus 10, 310 further includes an antenna 22 (i.e. a transmitter or radiator or microwave energy) that is arranged substantially within the heating chamber 12 and configured to supply the generated microwaves within the heating chamber 12. The antenna 22 is configured, by virtue of its geometry, to directly deliver the generated microwaves to the article (not shown) in a substantially uniform manner. The use of the antenna 22 allows for a relatively even “flooding” of the heating chamber 12 with electromagnetic waves that diffuse throughout the length of the antenna 22. This relatively uniform delivery of microwaves has the advantageous effect of heating the surface and/or interior of the article (not shown) in an even manner, which reduces the creation of ‘hot spots’ (or at least reduces areas of higher and lower temperature differential in or) on the article that often lead to burning or damage or the article.

The inclusion of antenna 22 in the heating chamber 12 advantageously improves the uniformity (in the intensity) of generated microwaves in the heating chamber 12. This improved (substantial) uniformity therefore reduces the need to rotate the article within the heating chamber to improve uniform heating of the article. The resultant substantially uniform heating of an object (such as article, organic matter or material) is intended to mean that the object is heated in a more uniform manner relative to if it were heated in a microwave heating apparatus without an antenna 22 located in the heating chamber 12. Uniform heating is not intended to mean that the object is heated perfectly uniformly. It is intended that uniform heating means that fewer ‘hot spots’ are created. This may also mean that a substantial portion of the object is heated to a certain temperature for an equivalent time at a predetermined temperature to ensure that a predetermined level of disinfestation is achieved. For example, it may be a requirement that at least 70% of the microorganisms over at least 90% of an object be disinfested. In some embodiments, at least 80% of the microorganisms over at least 90% of an object are to be disinfested. In some embodiments, at least 90% of the microorganisms over at least 90% of an object are to be disinfested.

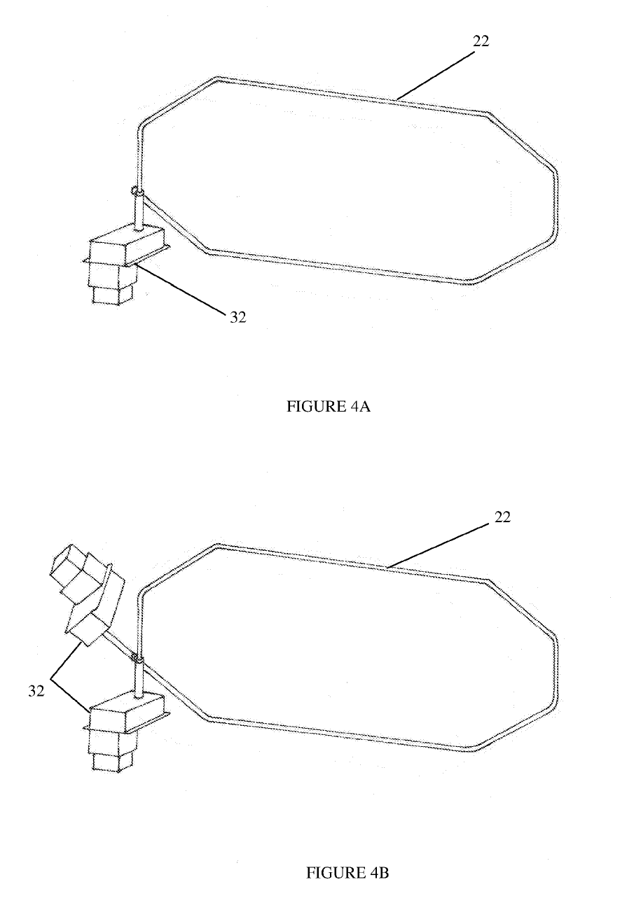

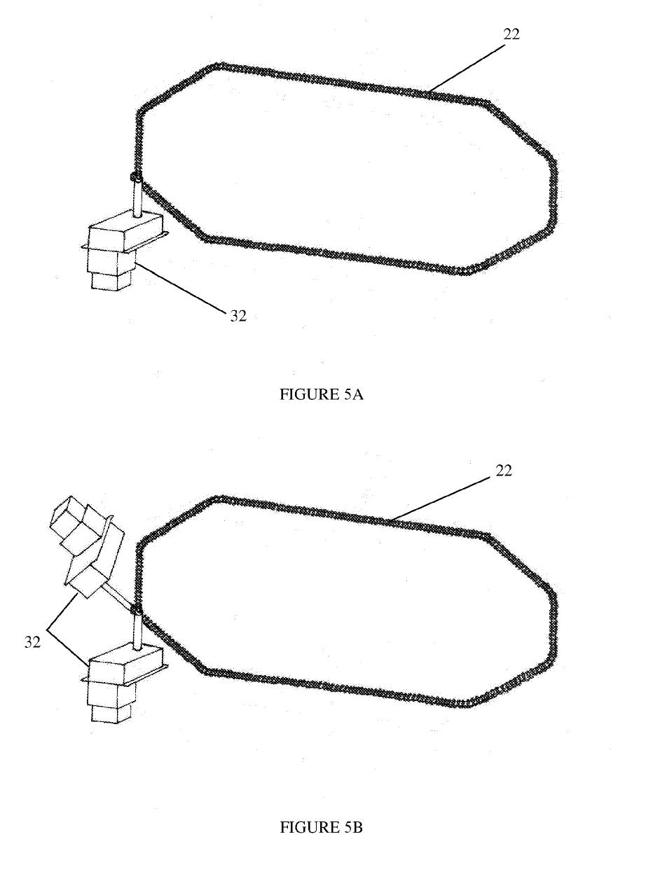

According to one embodiment, and as shown in FIG. 2, FIGS. 4A and 4B and/or FIGS. 5A and 5B of the drawings, the antenna 22 may include one or more co-planar loops that extend about the heating chamber 12. For example, in one embodiment (and as shown in FIG. 2 of the drawings), the antenna 22 may have an overall shape that approximates an ellipse as it extends about the heating chamber 12. As shown in FIG. 2 of the drawings, the antenna 12 may take the shape of, for example, an elongated hexagon or octagon that approximates an ellipse as it extends about the heating chamber. However, it should be appreciated that other geometries are also possible depending on the shape and/or configuration of the heating chamber 12.

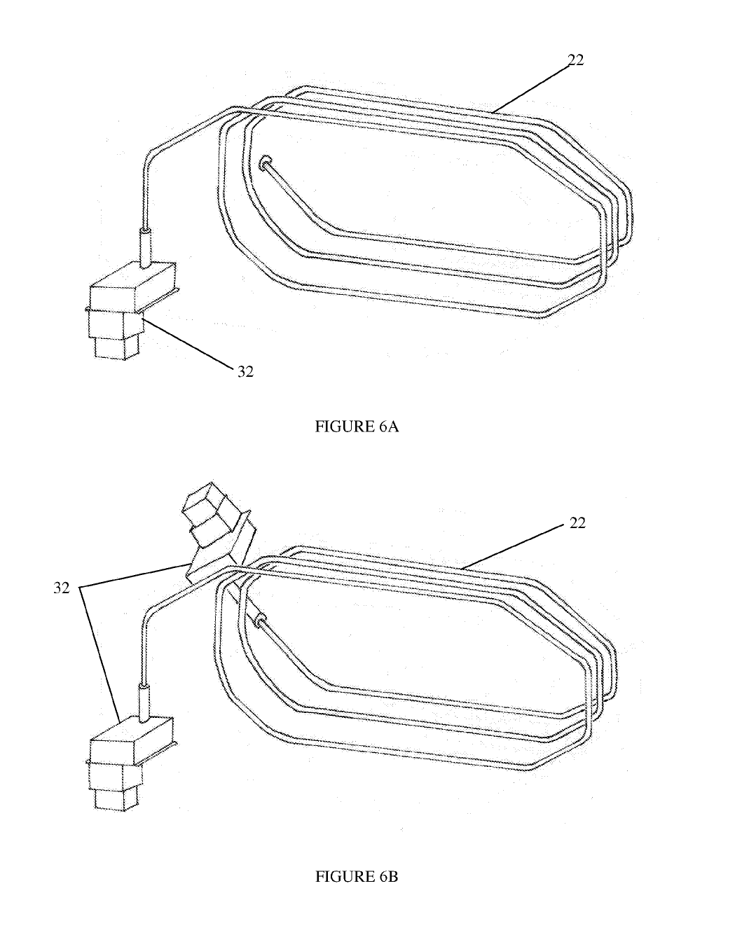

According to an alternate embodiment, and as shown in FIGS. 5A and 5B, and 6A and 6B of the drawings, the antenna 22 may be coiled in a helical configuration. An advantage of this configuration is that the electromagnetic wave supplied by the antenna simulates a rotating electromagnetic field when an article is conveyed through the heating chamber 12, which is understood to reduce energy focussing and provide a more uniform distribution (and heating) within the article (not shown) being heated.

The positioning of the antenna 22 within the heating chamber 12 will depend on the article to be heated, and the specific configuration of the heating chamber 12. For example, in a basic configuration, the antenna 22 may be located at the top of the heating chamber 12 (and above the article) so as to emit and directly deliver the generated microwaves to the article (not shown) in a substantially uniform manner. The reference in this paragraph to microwaves being ‘directly’ delivered to the article should be understood as referring to microwaves that travel directly from the antenna to the article, and excluding those microwaves that are received at the article after reflecting off an internal wall of the housing and/or heating chamber (i.e. microwaves that are ‘indirectly’ delivered to the article). Such a configuration assumes that the article will be placed approximately centrally within the heating chamber 12.

In an alternate embodiment, such as shown in FIG. 2 of the drawings, the antenna 22 may be located centrally to the heating chamber 12 such that, for example, a central axis 42 of the antenna 22 substantially aligns with the tunnel 40 created central to the housing 11 that is created between the first opening 16 and second opening 18. Alternatively, the antenna 22 may be located in any plane such that at least a portion of the article to be heated is surrounded by the antenna.

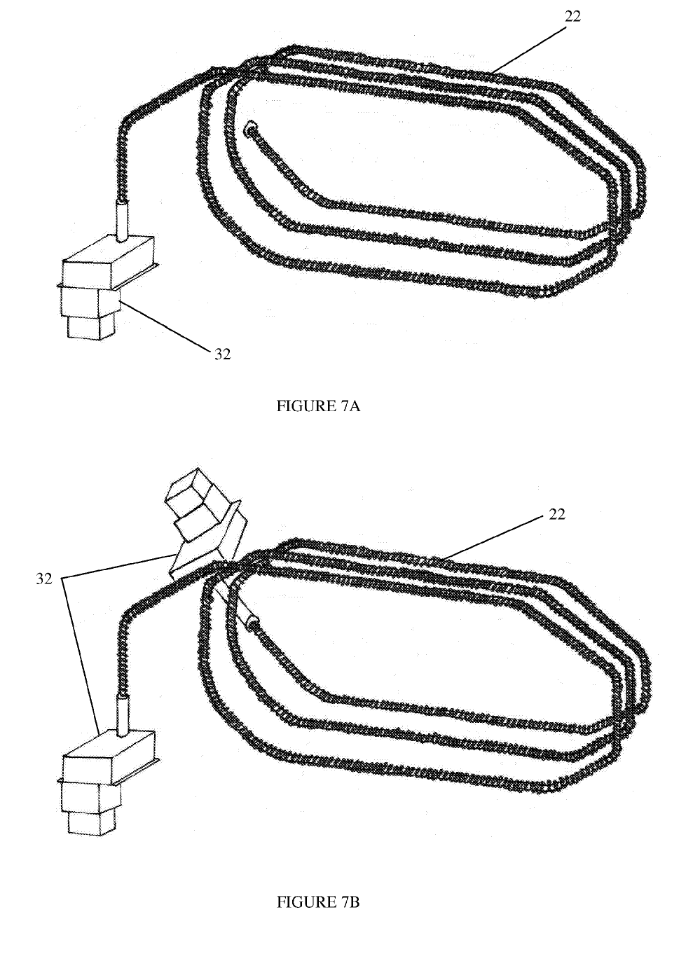

The antenna 22, in either the co-planar loop configuration and/or the helically coiled configuration, may also be configured with a plurality of helical turns along its length (such as shown in FIGS. 5A and 5B, and 7A and 7B of the drawings). In a preferred embodiment, the diameter of these turns is approximately 10 mm as this diameter closely approximates the diameter (i.e. thickness) of the co-planar loop antenna. However, it should be appreciated that other configurations are also possible depending on the type of antenna and type of microwave source used.

It should also be understood that additional materials may be incorporated within the heating chamber 12 to facilitate ease of use of the apparatus 10, 310 or to provide an improved cosmetic appearance. However, the references in this description to the electromagnetic shielding 14 defining at least a portion of the heating chamber 12 should be understood as defining the containment of the electromagnetic radiation within the heating chamber 12 and not necessarily the physical space itself. For example, a portion of the heating chamber 22 may be occupied by additional materials (e.g. non-conductive materials such as plastics) to cover and/or protect the antenna 22, or to assist with the mounting of the article (not shown) within the heating chamber 12.

As shown in FIG. 2 of the drawings, the internal profile of the electromagnetic shielding 14 is preferably configured to match the shape of the antenna 22. For example, and as shown in FIG. 2 of the drawings, the antenna 22 may have an extended octagonal shape that approximates an ellipse as it extends about the heating chamber 22. In a preferred embodiment, the surrounding profile of the electromagnetic shielding 14 (i.e. the cross section of the electromagnetic shielding) would also have a shape that approximates an ellipse, and more preferably an extended octagonal shape.

As seen in FIG. 2 of the drawings, the separation 24 between the antenna 22 and the electromagnetic shielding 14 is substantially uniform as the antenna 22 extends about the heating chamber 12. For example, and as previously discussed, if the antenna 22 has an overall shape that approximates an ellipse as it extends about the heating chamber 12, then the surrounding profile of the electromagnetic shielding 14 would also have a shape that approximates an ellipse, and have a relatively uniform separation from the antenna 22 as it extends about the heating chamber 12. In one embodiment, the separation 24 between the antenna 22 and the electromagnetic shielding 14 is preferably in the range of 5-25 mm, although this will naturally depend on the size and scale of the apparatus 10, 310. An advantage of this configuration is that any microwaves not directly delivered to the article (i.e. microwaves that are reflected from the electromagnetic shielding 14) are still directed to the article (not shown) in a relatively uniform manner due to the internal geometry of the electromagnetic shielding 14 and the substantially uniform separation 24 between the antenna 22 and the electromagnetic shielding 14. As a result, the heating of the article (not shown) maintains relative uniformity (i.e. no individual ‘hot spots’ are created during the heating of the article). In other words, the microwaves indirectly delivered to the article are delivered in a substantially uniform manner.

In some preferred embodiments, partially illustrated in FIGS. 2 & 3 of the drawings, the apparatus 10, 310 is configured for microwave disinfestation, and specifically postharvest disinfestation of insects, or heating an organic substance (e.g. fruits, vegetables, meat, fish, and certain liquids) to inhibit or prevent infestation without causing damage. In accordance with this embodiment, the apparatus 10, 310 is specifically configured for insect disinfestation on a product packaging line, but could equally be utilised for cooking, heating, drying, thawing, frying, extraction and/or tempering of a food product.

The microwave disinfestation apparatus 10, 310 includes a housing 11 that contains a heating chamber 12 adapted to receive organic matter (such as, for example, a food product) to be heated as part of a disinfestation process. The heating chamber 12 is at least partially defined by electromagnetic shielding 14. The electromagnetic shielding 14 is preferably constructed from a material that reflects and/or absorbs electromagnetic radiation such as, for example, sheet metal, metal mesh/screen, or metal foam. The electromagnetic shielding 14 illustrated in FIG. 2 and FIG. 3 of the drawings is sheet metal, although it should be appreciated that other suitable shielding materials could also be used.

The microwave disinfestation apparatus 10, 310 further includes a microwave source 30 located outside of the heating chamber 12, and being configured to generate microwaves. The microwave source 30 preferably includes a magnetron 32 configured to generate microwaves of a particular frequency, or within a predefined frequency range. The specific type of magnetron used may vary depending on the desired frequency of microwaves to be generated. However, the types of magnetrons may include single anode magnetrons, split anode magnetrons, cavity (or electron-resonance) magnetrons, or solid-state magnetrons.

The magnetron 32 is preferably powered by a regulated high-voltage power supply. A specific advantage of using such a power supply is that it avoids the need to regulate power through ‘pulsing’ (i.e. rapidly switching the power on and off), which in turn increases the longevity of the magnetron.

In some embodiments, the microwave disinfestation apparatus 10 may further include a conveyor 8 that extends through openings 16, 18 in the housing 11 and through heating chamber 12. The conveyor 8 is configured to convey the article (e.g. the food product) through the heating chamber 12 in an automated or semi-automated manner. For example, and in addition to microwave disinfestation treatment, the article may be subjected to additional processes (e.g. steam treatment) as it is conveyed along the conveyor 8 and through the heating chamber 12. In a preferred embodiment, the conveyor 8 is a conveyor system, such as a conveyor belt, that allows the article to be advanced through an opening 16, into the heating chamber 12 where microwave heat treatment is carried out, and then advanced through a further opening 18 for further treatment and/or packaging.

The microwave disinfestation apparatus 10, 310 further includes an antenna 22 (i.e. transmitter or radiator or microwave energy) arranged substantially within the heating chamber 12 and configured to supply the generated microwaves within the heating chamber 12. The antenna 22 is configured to directly deliver the generated microwaves to the organic matter (e.g. the food product) and bring about substantially uniform heating of the organic matter (not shown). The antenna 22 includes one or more of a co-planar antenna loop segment (as shown in FIG. 2, FIGS. 4A and 4B, and/or FIGS. 5A and 5B of the drawings) configured to electro-magnetically couple with the generated microwaves from at least one magnetron 32, and a helically-coiled antenna segment (as shown in FIGS. 6A and 6B and/or FIGS. 7A and 7B of the drawings) configured to electro-magnetically couple the generated microwaves from at least one magnetron 32.

FIGS. 4A and 4B, and FIGS. 5A and 5B of the drawings illustrate various embodiments of the antenna 22 in a co-planar loop configuration. In FIGS. 4A and 5A, the co-planar loop configuration of the antenna 22 is shown with a single magnetron 32 connected to one end of the antenna 22. In FIGS. 4B and 5B, the co-planar loop configuration of the antenna 22 is shown with magnetrons 32 connected at both ends of the antenna 22.

FIGS. 6A and 6B, and 7A and 7B of the drawings illustrate various embodiments of the antenna 22 in a helically-coiled configuration. In FIGS. 6A and 7A, the helically-coiled configuration of the antenna 22 is shown with single magnetron 32 connected to one end of the antenna 22. In FIGS. 6B and 7B of the drawings, the helically-coiled configuration of the antenna 22 is shown with magnetrons 32 connected at both ends of the antenna 22. It should be understood that alternative variations and/or combinations of these configurations are also possible depending on the particular application. For example, magnetrons 32 may also be connected at points along the length of the antenna 22 in either the co-planar loop configuration or helically-coiled configuration of the antenna 22.

The antenna 22, in either the co-planar loop configuration and/or the helically coiled configuration, may also be configured with a plurality of helical turns along its length (such as shown in FIGS. 5A and 6B, and 7A and 7B of the drawings). In a preferred embodiment, the diameter of these turns is approximately 10 mm as this diameter closely approximates the diameter (i.e. thickness) of the co-planar loop antenna. However, it should be appreciated that other configurations are also possible depending on the type of antenna and type of microwave source used. Depending on the specific configuration, the antenna 22 may include a sequence of consecutive co-planar antenna loop segments (as shown in FIG. 2 of the drawings, where two co-planar antenna loop segments are shown in sequence) and/or helically-coiled antenna segments that extend about the heating chamber 12. In such a configuration, the sequence of co-planar antenna loop segments and/or helically-coiled antenna may be in connection with one or more magnetrons 32 that generate the required microwaves.

### Example

A specific example of the apparatus 10, 310 configured for microwave disinfestation will now be described in relation to the treatment of fruit fly species (B. tryoni, B. jarvisi, B. neohumeralis and B. cucumis) infesting capsicum and zucchini for the development.

An experimental study was conducted to evaluate the performance of the microwave disinfestation apparatus 10. The microwave disinfestation apparatus 10, 310 used in this study is represented in FIG. 2 and FIG. 3 of the drawings, and includes a housing 11 containing a heating chamber 12 defined by electromagnetic shielding 14 (namely, sheet metal) extending around and enclosing the heating chamber 12 during the heat treatment process. This enclosure of the heating chamber 12 is best depicted in FIG. 3 of the drawings. The apparatus 10, 310 further includes a microwave source 30 in the form of two magnetrons 32, that are each connected to a co-planar antenna loop 22 (e.g. a coaxial antenna) that extends about the heating chamber 12. As can be seen in FIG. 2 of the drawings, the antenna 22 used have an extended octagonal shape that approximates an ellipse. Similarly, the surrounding profile of the electromagnetic shielding 14 (i.e. the cross section of the electromagnetic shielding 14) has an extended octagonal shape that also approximates an ellipse.

The apparatus 10, 310 was used to heat treat eleven zucchinis or seven capsicums per batch. Several treatment combinations were developed for capsicum and zucchini by varying the power level of 25%-30% and treatment times. Preliminary microwave heating protocol development trials (8, in total) were conducted for zucchini and capsicum initial temperature of 25.0±2.2° C. and 24.7±1.1° C. respectively. The temperature of treated vegetables was measured in real time using fibre optic cables placed at different locations around selected vegetables distributed horizontally along the heating chamber 12. This temperature data was then used to calculate equivalent time at 45° C. (M₄₅) and 52° C. (M₅₂) for zucchini and capsicum respectively. A microwave treatment protocol was selected for each crop and used in quality evaluation trials on the basis of the most rapid heating rate and uniformity of heating. The microwave treated vegetables were cooled down immediately after heat treatment in an 8° C. cold room and stored for 2 weeks.

The effect of the selected microwave treatment on zucchini quality was evaluated on day 1, 6, 9, 12 and 15 using a subjective score system based on the appearance at stem end and flower end, internal appearance, vegetable colour, pitting size, pitting coverage and firmness. The effects of the selected microwave treatment on capsicum quality were evaluated on 1^{st}, 4^{th}, 7^{th}, 12^{th} and 15^{th} day using a subjective score system based on the external quality, vegetable colour, firmness, pitting, burning, stem and calyx colour and internal quality. Quantitative assessments on weight, impedance, total soluble solids and pH were also conducted.

Two Reflex 4 channel fibre optic conditioner temperature measurement systems (Neoptix Inc., Quebec, Canada) each with 4×6 m fibres was used to record the real time temperature profile of the capsicums and zucchini inside the microwave disinfestation apparatus 10, 310. The fibre tips were inserted into selected fruits, and temperature measurements were recorded at 5 second intervals and the temperature data was used to calculate the equivalent time at a target temperature of 52° C. for capsicum (mortality time M₅₂, equation 1) and at 45° C. for zucchini (M₄₅).

The z-values used for Mediterranean fruit fly (Diptera: Tephritidae; Ceratitis capitata, Weidemann) eggs and 3rd instar larvae were 4.1 and 3.6° C., respectively. Heat tolerance of Mediterranean fruit fly is considered to be similar to Queensland fruit fly:

$${M}_{52} = {\int }_{0}^{t} {10}^{\frac{T ( t ) - 52 ° C .}{z}} dt$$

Where M₅₂ is the equivalent time at a target temperature of 52° C., T (t) is the transient temperature profile measured by the fibre optic system, t is the time and z is the temperature change (in ° C.) required to change the value of insect mortality (lethality) by a factor of 10.

A microwave pulse program was utilized for all experiments, the program involving the delivery of a short microwave pulse followed by an equilibration period where the microwave power was turned off. This process was repeated in until the target treatment temperature was attained.

With respect to the treatment of zucchinis, each experiment was conducted in batch mode and eleven fruits were placed inside the heating chamber 12. The temperature was measured in two zucchini fruits, with the ‘Treatment 2’ treatment parameters (shown in Table 1 below) being selected for quality evaluation trials.

With respect to the treatment of capsicums, each experiment was conducted in batch mode and seven fruits were placed inside the heating chamber 12. The temperature was measured in three capsicum fruits (namely, far left, middle and far right), with the ‘Treatment 6’ treatment parameters (shown in Table 2 below) being selected for quality evaluation trials.

Results revealed the new microwave disinfestation apparatus 10, 310 could be used effectively at 25%-30% (i.e. approximately 250-300 W) power to heat zucchini and capsicum from an initial temperature to 40° C. within 15-25 mins and 22-37 mins respectively. Microwave heating proved faster than the vapour heat treatment (VHT) heating times calculated for zucchini (90 min) and capsicum (60 min) based on known testing protocols. The temperature variation of vegetables at different locations in the heating chamber 12 and at different locations within a vegetable was minimal. Results showed that the new microwave disinfestation apparatus 10, 310 could be used to successfully heat and disinfest several vegetables at a time when operating in batch mode.

The microwave disinfestation apparatus 10, 310 described may also have application in relation to the treatment of other economically significant pest for the vegetable industry (e.g. other fruit fly types of importance such as Mediterranean fruit fly (med fly, Ceratitis capitata), other pest types (such as, for example, mealy bugs, thrips and potato nematodes), and various plant pathogens. In addition, the apparatus 10, 310 may be configured for the treatment of cut flowers, ornamental plants, potting media and seeds to eradicate pests and plant pathogens. Heat treatments using the apparatus 10, 310 may also be developed to control ripening, senescence or prevent chilling injury, physiological disorders and postharvest diseases of horticultural crops.

In some applications, the method of disinfestation and disinfestation apparatus 10, 310 may be used to destroy, kill or otherwise render impotent or inactive other micro-organisms such as bacteria, fungi, virus, mycoplasma and protozoa.

Further, the apparatus 10, 310 may also be configured for specific applications such as weed eradication, treatment of plant pathogens and soil treatment. In such alternate embodiments, it is envisaged that the apparatus 10, 310 may be mounted to an agricultural vehicle (not shown), which is driven in a manner so as to cause soil to pass through the housing 11 and within the heating chamber 12 of the apparatus 10, 310. Such embodiments of the apparatus 10, 310 have a configuration of the heating chamber 12 such that no electromagnetic shielding 14 is provided on the bottom surface of the apparatus 10, 310. This type of configuration would allow direct delivery of microwaves to the soil being treated. As such, methods of microwave treatment, and particularly microwave disinfestation treatment, using the above described microwave heating apparatus are also to be appreciated as falling within the scope of the disclosure provided herein.

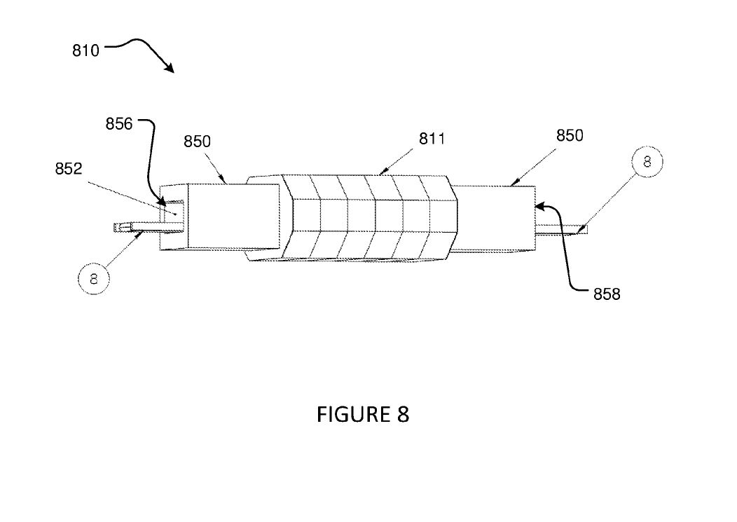

FIG. 8 shows a microwave heating apparatus 810 for continuous heat treatment of material. The apparatus 810 includes a housing 811 that contains heating chamber 12 and electromagnetic shielding 14 (not shown). The apparatus 810 further includes at least one microwave source 30 for generating microwaves (not shown). Each of the at least one microwave sources 30 includes a magnetron 32 for generating microwaves of a particular frequency (e.g. 2.45 GHz) or within a desired frequency band (e.g. the S-band in the range of 2 to 4 GHz). The apparatus 810 also includes at least one antenna 22 arranged substantially within the heating chamber 12 and configured to supply the generated microwaves within the heating chamber 12. The at least one antenna 22 is configured, by virtue of its geometry, to directly deliver the generated microwaves to the material (such organic matter or an article) in the heating chamber 12 in a substantially uniform manner. The housing 811 and heating chamber 12 may be elongate along the central axis 42 defined by the antenna 22.

In some embodiments, each of the at least one antennas 22 are independently coupled to the at least one microwave source 30. Each of the at least one antenna 22 may be located in a different portion of the heating chamber 12 and independently coupling them to different microwave sources enables the microwaves generated in the different portions of the heating chamber 12 to be independently controlled. This can be used to adjust and control the generated microwaves to enable a substantially uniform heating of material in the heating chamber. The at least one microwave sources 30 may be coupled to a controller including a processor for adjusting and/or controlling the generation of microwaves.

In some embodiments, the apparatus 810 may also include a conveyor 8 that extends into the heating chamber 12. The conveyor 8 may also extend through the heating chamber 12. The housing 811 may also at least in part define a tunnel 40 that the conveyor 8 extends into and/or through. The conveyor 8 may be configured to continuously introduce material into the heating chamber 12 and continuously remove the material from the heating chamber 12. The continuous operation of the conveyor 8 advantageously enables a greater amount of material to be heat treated or disinfested, when compared to a batch method where material is periodically loaded into and removed from the heating chamber 12.

In some embodiments, the conveyor 8 may be coupled to a control system 2 or control devices 4 including a processor for controlling the operation of the conveyor 8. The conveyor controller may, for example, operate to maintain a constant speed of a conveyor belt through the tunnel 40. The conveyor controller may also be coupled to sensor devices 5 to monitor the speed of the conveyor belt. For example, the control system 2 may include a proportional-integral-derivative (PID) controller coupled to the sensor and operating in a feedback loop to maintain the constant speed.

In some embodiments, the microwave heating apparatus 810 includes a plurality of microwave heating apparatuses 10 adjacent or abutting each other so as to be concatenated. The plurality of microwave heating apparatuses 10 collectively define housing 811. Each microwave heating apparatus 10 includes an antenna and a heating chamber 12 that defines a portion of heating chamber 912. The antenna 22 may therefore include the plurality of antenna in each microwave heating apparatus 10. The antenna 22 may include a plurality of loop segments. This modular design advantageously provides ease of assembly and flexibility in providing different lengths along the central axis 42 for the housing 811 and heating chamber 12. The different lengths provide a further degree of freedom in adjusting or optimising the conditions under which material within the heating chamber 12 can be heated. For example, a longer heating chamber 12 may enable the material to be heated for longer compared to a shorter heating chamber 12 where the material travels through the heating chamber 12 at the same or similar speed. This advantageously enables the total throughput of the microwave heating apparatus 810 to be adjusted which may be important for commercial applications.

In the embodiment shown in FIG. 8, there are six heating chambers 12 concatenated to define housing 811. In some embodiments, each of these heating chambers 12 may include one antenna loop, two antenna loops or more than two antenna loops.

In some embodiments, the apparatus 810 may include at least one shield 850 at one or more ends of the housing 811. The shield 850 being configured to reduce or attenuate the energy of the generated microwaves in at least a portion of the volume external to the housing 811. The shield 850 defines a tunnel 852 that is open at both ends and connected with tunnel 40 at one end to enable conveyor 8 to pass through both tunnels 40, 852. The ends of tunnel 40, 852 may define an opening 856 for material to be introduced therein and a further opening 858 for material to be removed from the tunnel 40, 852 and thereby the heating chamber 12.

In some embodiments a cover is provided over the openings 856, 858 of the tunnel 40, 852. The cover is adapted so as to enable material to be conveyed into the tunnel 40, 852 unimpeded and thereby enabling continuous introduction and removal of material. As an example, the cover may be a flap or a set of flaps that are flexible and or rotatable to enable material to pass by the cover. The cover advantageously restricts the air flow through, into or out of the tunnel 40, 852 which may assist in substantially uniformly heating of the material within the heating chamber 12. The cover may also be useful in reducing the amount of radiation external to the housing 811; this is of particular importance in applications where high microwave power is used.

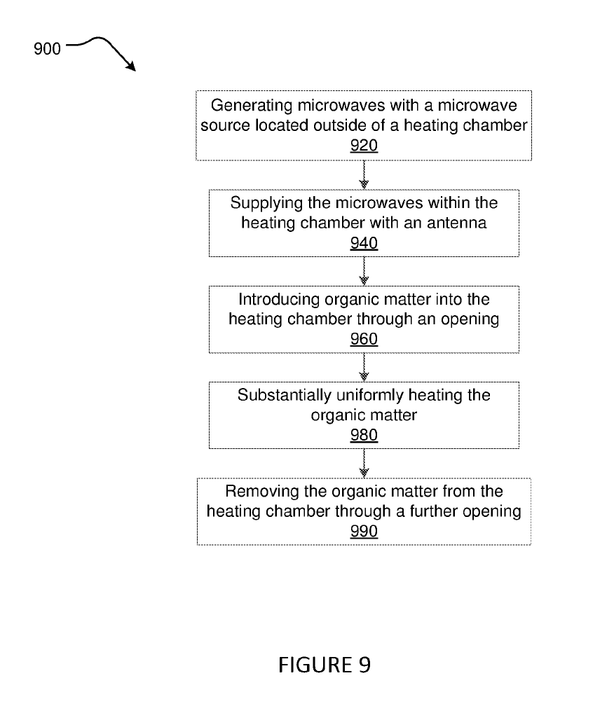

Referring to FIG. 9, there is provided a method 900 of heat treating material such as organic matter with a microwave heating apparatus 10, 810. The microwave heating apparatus 10, 810 includes a microwave source 30 located outside of a heating chamber 12. The method 900 includes generating microwaves with the microwave source 30, at 920, and supplying the generated microwaves within the heating chamber 12, at 940. The generated microwaves are supplied with an antenna 22 arranged substantially within the heating chamber 12 and the antenna 22 comprises a loop that extends about the heating chamber 12. For example, the antenna 22 may extend about an internal circumference of the heating chamber 12. The method 900 also includes introducing the material into the heating chamber 12 through an opening of the heating chamber, at 960. The method 900 further includes substantially uniformly heating the material, at 980; and removing the material from the heating chamber through a further opening of the heating chamber, at 990. The loop of the antenna extending about the heating chamber 12 advantageously enables the material to be substantially uniformly heated.

The generated microwaves may, in some embodiments, be generated as pulsed microwaves. The method 900 includes first generating the microwaves 940 and then introducing the organic matter 960 into the heating chamber 12. In some embodiments, the method 900 includes introducing 960 the material into the heating chamber 12 and then generating 940 microwaves.

In some embodiments, the method 900 may include cooling the organic matter after it has been heated. This may include only exposing the organic matter to the lower ambient air temperatures as it is conveyed along the conveyor 8. In some embodiments, air or other gases or liquids which are cooler than the heated organic matter may be applied to the organic matter to cool it down. In other embodiments, the organic matter may be immersed in a liquid that is cooler than the heated organic matter to cool the organic matter. For example, the organic matter may be immersed into water at a temperature in the range of about 2° C. to about 10° C. in a ‘hydro-cooling’ step. In some embodiments, the organic matter may be immersed into water at a temperature in the range of about 2° C. to and about 6° C. in a ‘hydro-cooling’ step.

In some embodiments, the steps of introducing 960 and removing 990 in method 900 are continuous processes. Organic matter may be continuously introduced into and continuously removed from the heating chamber 12.

The organic matter in the heating chamber 12 may, as a result of being heating by the generated microwaves, be substantially uniformly heated for a predetermined equivalent time at a predetermined temperature. This accounts for being exposed to varying temperatures as it is being heated and while it is being cooled. In order to disinfest the organic matter there may have been determined a mortality time M_{T} at predetermined temperature T for a particular pest or micro-organism to be disinfested. The predetermined equivalent time may therefore be set at a value that is at least equal to the mortality time M_{T}. For example, in the treatment of fruits and/or vegetables, the predetermined temperature may be in the range of 40° C. to 60° C. The predetermined equivalent time may be in the range of 10 to 60 minutes. As an example, at a predetermined temperature of 52° C., the predetermined equivalent time at this temperature may be set to a value in the range of either 15 to 25 minutes or 26 to 40 minutes depending on the type of pest to be disinfested from the organic matter.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A microwave heating apparatus including:
a housing that contains a heating chamber adapted to receive an article to be heated, the chamber being at least partially defined by electromagnetic shielding;
a microwave source for generating microwaves, the microwave source being located outside of the heating chamber; and
an antenna arranged substantially within the heating chamber and configured to supply the generated microwaves substantially within the heating chamber, the antenna being configured to directly deliver the generated microwaves to the article in a substantially uniform manner.

2. The microwave heating apparatus according to claim 1,
wherein the housing is configured with a first opening to facilitate introduction of the article to the heating chamber, and
wherein the housing is configured with a second opening to facilitate removal of the article from the heating chamber.

3. (canceled)

4. The microwave heating apparatus according to claim 2, further including a conveyor that extends into the heating chamber, wherein the first and second openings are one and the same.

5. The microwave heating apparatus according to claim 2, further including a conveyor that extends into and through the heating chamber,
wherein the first and second openings are separate and distinct, and
wherein the housing defines a tunnel that extends through the heating chamber.

6-8. (canceled)

9. The microwave heating apparatus according to claim 1, wherein the antenna is a co-planar loop that extends about the heating chamber.

10. The microwave heating apparatus according to claim 9, wherein the antenna has an overall shape that approximates an ellipse as it extends about the heating chamber.

11. The microwave heating apparatus according to claim 9, wherein the antenna is coiled in a helical configuration.

12. The microwave heating apparatus according to either claim 10, wherein the antenna is configured with a plurality of helical turns along its length.

13. The microwave heating apparatus according to claim 1, wherein the electromagnetic shielding is constructed from a material that reflects and/or absorbs electromagnetic radiation.

14. The microwave heating apparatus according to claim 1, wherein an internal profile of the electromagnetic shielding is configured to match the shape of the antenna.

15. The microwave heating apparatus according to claim 1, wherein the separation between the antenna and the electromagnetic shielding is substantially uniform as the antenna extends about the heating chamber.

16-17. (canceled)

18. A microwave disinfestation apparatus including:
a housing that contains a heating chamber adapted to receive organic matter to be heated, the chamber being at least partially defined by electromagnetic shielding;
a microwave source for generating microwaves, the microwave source being located outside of the heating chamber;
a conveyor that extends through openings in the housing, the conveyor being configured to convey the article through the heating chamber; and
an antenna arranged substantially within the heating chamber and configured to supply the generated microwaves within the heating chamber, the antenna being configured to directly deliver the generated microwaves to the organic matter and bring about substantially uniform heating of the organic matter.

19. The microwave disinfestation apparatus according to claim 18, wherein the antenna includes one or more of:
a co-planar antenna loop segment coupled to at least one magnetron; and
a helically-coiled antenna segment coupled to at least one magnetron.

20. The microwave disinfestation apparatus according to either claim 18, wherein the antenna is configured with a plurality of helical turns along its length.

21. A method of heat treating organic matter with a microwave heating apparatus including a microwave source located outside of a heating chamber, the method including:
generating microwaves with the microwave source;
supplying the generated microwaves within the heating chamber with an antenna arranged substantially within the heating chamber, wherein the antenna comprises a loop that extends about an internal circumference of the heating chamber;
introducing the organic matter into the heating chamber and through the loop via an opening of the heating chamber;
heating the organic matter with the generated microwaves;
removing the organic matter from the heating chamber through a further opening of the heating chamber.

22. (canceled)

23. The method according to claim 21, wherein the organic matter is continuously introduced into and continuously removed from the heating chamber.

24. The method according to claim 21, wherein generating microwaves includes generating microwave pulses.

25. The method according to claim 21, wherein the organic matter is substantially uniformly heated for a predetermined equivalent time at a predetermined temperature.

26. The method according to claim 25, wherein the predetermined temperature is in the range of 40° C. to 60° C.

27. (canceled)

28. The method according to claim 25, wherein the predetermined equivalent time at the predetermined temperature is in the range of 10 to 60 minutes.

29. (canceled)

30. The method according to claim 21, wherein the microwave heating apparatus is defined in accordance with claim 1.

31. (canceled)
